(19) United States
(12) Patent Application Publication
(10) Pub. No.: US 2007/0037610 A1
(43) Pub. Date: Feb. 15, 2007

(54) Methods and apparatus for conserving battery power in a cellular or portable telephone

(76) Inventor: James D. Logan, Candia, NH (US)

Correspondence Address: CHARLES G. CALL, 68 HORSE POND ROAD, WEST YARMOUTH, MA, 02673-2516, US

(21) Appl. No.: 11/582,600

(22) Filed: Oct. 18, 2006

Related U.S. Application Data
(63) Continuation-in-part of application No. 10/984,018, filed on Nov. 8, 2004.
Application No. 10/984,018 is a continuation-in-part of application No. 10/160,710, filed on May 31, 2002, now Pat. No. 6,816,577.
Application No. 10/984,018 is a continuation-in-part of application No. 10/680,643, filed on Oct. 7, 2003, now Pat. No. 6,996,402.
Application No. 10/680,643 is a continuation-in-part of application No. 09/651,542, filed on Aug. 29, 2000, now Pat. No. 6,631,271.
Application No. 10/680,643 is a continuation-in-part of application No. 10/160,711, filed on May 31, 2002, now Pat. No. 6,788,766.
(60) Provisional application No. 60/728,162, filed on Oct. 19, 2005.
(60) Provisional application No. 60/295,469, filed on Jun. 1, 2001.
(60) Provisional application No. 60/295,404, filed on Jun. 2, 2001.

(51) Int. Cl. H04B 1/38

(52) U.S. Cl. 455/574

(57) ABSTRACT

A cellular telephone automatically places itself in a sleep mode in which one or more components are de-eneragized to conserve battery power whenever sensed status variables indicated that the telephone will not or cannot be used. The user can schedule time periods during which the phone will be in sleep mode and can establish conditional rules which establish conditions which, if satisfied, will place the phone in a sleep mode. Sensed variables such as ambient light and sound, the time of day, applied pressure, and the location and movement of the phone are processed along with user-defined preference values to begin and end automated sleep modes.

### CROSS REFERENCE TO RELATED PATENT APPLICATION

This application is a non-provisional of and claims the benefit of the filing date of U.S. Provisional Patent Application Ser. No. 60/728,162 filed on Oct. 19, 2005 by James D. Logan entitled “Methods and apparatus for conserving battery power in a cellular or portable telephone,” the disclosure of which is incorporated herein by reference.

This application is also a continuation in part of U.S. patent application Ser. No. 10/984,018 filed on Nov. 8, 2004 by James D. Logan and Caren Thomburgh-Logan entitled “Communication and control system using a network of location aware devices for message storage and transmission operating under rule-based control” published as U.S. Patent Application Publication No. 2005/0153729 A1 on Jul. 14, 2005. application Ser. No. 10/984,018 was a continuation in part of U.S. patent application Ser. No. 10/160,710 filed May 31, 2002 which issued as U.S. Pat. No. 6,816,577 on Nov. 9, 2004, and which claimed the benefit of the filing date of Provisional U.S. Patent Application Ser. No. 60/295,469 filed on Jun. 1, 2001. application Ser. No. 10/984,018 was also a continuation in part of U.S. patent application Ser. No. 10/680,643 filed on Oct. 7, 2003 which issued as U.S. Pat. No. 6,996,402 on Feb. 7, 2006 and which was a continuation in part of U.S. patent application Ser. No. 09/651,542 filed Aug. 29, 2000 issued as U.S. Pat. No. 6,631,271 on Oct. 7, 2003 and of U.S. patent application Ser. No. 10/160,711 which was filed on May 31, 2002 and issued as U.S. Pat. No. 6,788,766 on Sept. 7, 2004, and which claimed the benefit of the filing date of Provisional U.S. patent application Ser. No. 60/295,404 filed on Jun. 2, 2001.

This application claims the benefit of the filing date of each of the above-noted applications, and incorporates the disclosures of each of the foregoing patents and applications herein by reference.

### BACKGROUND OF THE INVENTION

1. Field of the Invention

This invention relates to methods and apparatus for conserving battery power in a cellular or portable telephone.

2. Discussion of the Problem and Prior Solutions

Cell phone batteries will eventually discharge, occasionally leaving the user with no service at a critical moment. To reduce power consumption, the cell phone may be periodically placed in a “sleep mode” under certain conditions to reduce battery power consumption as described in the following U.S. Patents, the disclosures of which are incorporated herein by reference:

U.S. Pat. No. 5,590,396 issued to Raymond C. Henry (Ericsson Inc.) on Dec. 31, 1996 entitled “Method and apparatus for a deep-sleep mode in a digital cellular communication system” describes a method for extending the battery life of a cellular radiotelephone by conditioning it to operate in a pager-only mode to receive short messages from a base station while conserving battery life by cyclically adopting a deep-sleep state. The base station is notified before the cell phone enters the deep-sleep state that it is unable to receive messages. After a period of time, the cell phone wakes-up, re-establishes contact with the base station and notifies the base station that the cell phone is ready to receive messages. After receipt of any messages the cell phone repeats the process.

U.S. Pat. No. 5,790,941 issued to George M. Peponides (Pacific Communication Sciences, Inc.) on Aug. 4, 1998 entitled “Method and apparatus for regenerating the symbol clock of a cellular telephone following a sleep cycle” describes another method for reducing power consumption in a cellular telephone by placing the receiver in a sleep mode when it is determined that the received signal has a sufficiently high quality. The duration of the sleep mode is extended by a resynchronizing technique for eliminating the need to resynchronize the receiver clock to the transmitter clock using dotting sequence and synchronizing data in the transmitted control data received after a sleep cycle.

U.S. Pat. No. 6,058,289 issued to Gardner, et al. on May 2, 2000 entitled “Method and apparatus for low power mobile unit for cellular communications system” describes a cell phone that enters Sleep-Mode when no communications have occurred between the cell phone and the Base Station over a predetermined amount of time measured by an “Idle Timer”. Upon expiry of a Wake Timer, the Mobile Unit awakes from Sleep-Mode to determine whether a message is pending. Concurrently, the Base Station transmits a “TEI-Notification” message directed to all Mobile Units. Upon waking to receive a TEI-Notification message, the Mobile Unit determines whether the quality of the transmission is at least sufficient to allow the Mobile Unit to decipher the TEI-Notification message. If this minimal requirement is met, and the TEI-Notification message does not indicate that data is pending for the Mobile Unit, the Mobile Unit returns to sleep.

U.S. Pat. No. 6,223,047 issued to Ericsson on Apr. 24, 2001 entitled “Extended sleep mode method and apparatus” describes a power saving standby mode that reduces the consumption of power in which a base station transmits a message comprising repeated data words. Upon receiving a first word of the message, the power supplied to at least a receiver unit in the cellular phone is powered down. Decoding, CRC checking and MIN comparison of the received message are performed after the receiver unit has powered down.

U.S. Pat. No. 6,628,972 issued to Lee on Sept. 30, 2003 entitled “Power saving method of mobile telephone” describes a method for setting a power saving time period when the present time coincides with the set time, implementing a power saving function; designating a cycle for checking a paging channel slot, and checking the paging channel slot by supplying a power of a battery to a radio frequency control part every designated cycle. While these mechanisms do provide power savings, they all continually recycle between a sleep state and an active state, even in circumstances when the likelihood that the cell phone will be used is very small.

### SUMMARY OF THE INVENTION

The following summary provides a simplified introduction to some aspects of the invention as a prelude to the more detailed description that is presented later, but is not intended to define or delineate the scope of the invention.

It is an object of this invention to reduce the energy consumed by a battery operated cellular or portable telephone.

Embodiments of the invention are employed to automate the selection of an appropriate mode of operation of a portable telephone in order conserve power when some or all of the telephone's functionality is not needed, or unlikely to be needed; for example, to automatically switch the phone into a sleep mode when conditions specified by the user are satisfied, or when sensed status variables indicate that it is appropriate to place the phone in sleep mode. These status variables may be acquired by sensing the location of the portable phone, or of persons and objects near to the portable phone, and/or by sensing the characteristics of the environment in which the portable phone is being used, including the time of day and day of the week.

Substantial power conservation may be achieved by accepting from the user a schedule indicating the times when the phone is unlikely to be used, and automatically placing the telephone in the sleep mode at those specified times.

Variations in mode settings of the portable telephone may be automated without needing attention from the user by responding to information indicating the location or mode of use of the phone, or changes in the environment in which the phone is used or the character of the calling party.

The preferred embodiment of the invention determines which instrumentalities in the telephone should remain active and under power, and which can be turned off or operated under conditions where they consume less power (e.g., at reduced clock rates). In addition, the magnitude or timing of the alert signal (e.g. ringing signal) generated to notify the user of a portable (e.g. cellular) telephone of an incoming phone call may be controlled when the phone is activated to accept incoming calls in order to better alert the called party or to minimize annoyance to others near the phone. Data values that indicate the status of the telephone or its user are processed to control the character of the sleep mode and the alert signals. These data values may include position data indicating the absolute location of the phone or its relative location with respect to another object, the level of ambient light or sound in the vicinity of the telephone, the time of day, the movement of the telephone, and/or whether the telephone is being held by the user.

The preferred embodiment can control a portable telephone (e.g. a cellular handset) by acquiring an indication of the current position of said portable telephone, and control the sleep mode status as well as produce a desired alert wherein the sleep mode and the alert have operating characteristics that are dependent upon the acquired position indication. The position indication may describe the absolute geographic location of the telephone, or its position relative to the current location of another object, person or region determined by detecting a signal produced by a beacon at a known location of said portable telephone.

The sleep mode and alert signals may be varied in response to acquired status indications, including not only the relative or absolute location of the telephone but also sensed ambient conditions, such as whether the telephone is in the dark, the ambient sound level at the telephone, the time of day, whether the telephone is being held by the user, and the nature of the incoming call or caller. These data values may be used alone or in combination to alter the manner in which components of the telephone are powered, and the attributes of the alert signals produced. Programmed rules, each of which specifies one or more conditions that are to be satisfied, and an action specification that specifies the function or power levels to be controlled when these conditions are satisfied, may used to evaluate the status data and to alter the operation of the telephone in manner that is appropriate in different situations.

The mechanisms used to acquire the needed status data may include GPS or MPS subsystems for determining the absolute location of the portable phone; sensors for detecting and/or measuring the magnitude of signals received from identifiable beacon transmitters at known locations, sensors for detecting ambient light, sound, pressure which help determine the likely status of the telephone, and a built-in accelerometer that may be used to determine when and how the telephone has been subjected to movement.

Based on the determination of the status of the portable telephone derived from one or more of these acquired data values, the processor controls manner in which the powered components of the telephone are operated and the mode, magnitude and timing of the alert signal. The likelihood that the user will be able to use the telephone as determined or inferred from the acquired status data can be used to prevent needless power consumption when the phone is unlikely to be used.

These and other objects, features and advantages of the invention may be better understood by considering the following detailed description of specific embodiments of the invention.

These and other objects, features and advantages of the invention may be better understood by considering the following detailed description of specific embodiments of the invention.

### BRIEF DESCRIPTION OF THE DRAWINGS

In the detailed description which follows, frequent reference will be made to the attached drawings, in which:

FIG. 1 is a block diagram illustrating the principal components of a cellular telephone that may be used to implement embodiments of the present invention; and

FIG. 2 is a front view of the cellular telephone showing the display screen, keypad and other elements of the user interface provided to enable the user to control cellphone operation.

### DETAILED DESCRIPTION

In this specification, the term “portable telephone” or “portable phone” refers to mobile or cellular telephones which communicate by long distance radio signaling with individual base stations or base stations in a communications network, as well as to portable telephones which communicate using shorter range radio signaling with a local base station typically in a home or office. Portable telephones are commonly powered by rechargeable batteries which are typically recharged using a separate charger located in the home or office. When the user is away from the charger for an extended time, or forgets to recharge the batteries, the level of charge can be depleted over time to the point where the portable phone cannot be operated as intended. This problem is more severe for cellular phones than for portable household phones which are placed in a charging cradle when not in use. In general, however, the principles of the present invention may be used to advantage for any battery powered telephone.

The terms “SLEEPY” (an acronym for “Sleep Enhanced Power Yields”) is employed here to describe a number of related methods that may be used alone or in combination to conserve the battery power of a portable telephone.

Portable Phone Implementations

The specific embodiment to be described implements novel features for conserving battery power that may be readily incorporated into existing cellular telephones. Cellular phones now typically include one or more microprocessors and sufficient memory resources to perform complex computational tasks. In addition, advanced cellular phones often include a Bluetooth short range signaling system which provides a communications interface to nearby devices and peripheral resources, as well as Wi-Fi connectivity to the Internet for data and voice communications over channels which may be independent of the cellular network. Moreover, the cellular phones normally include a display screen which may be used in combination with an included keypad to provide a robust user interface for accepting commands and preference data from the user. As described below, this user interface may be employed to permit the user to customize the manner in which special functions are performed to conserve battery power.

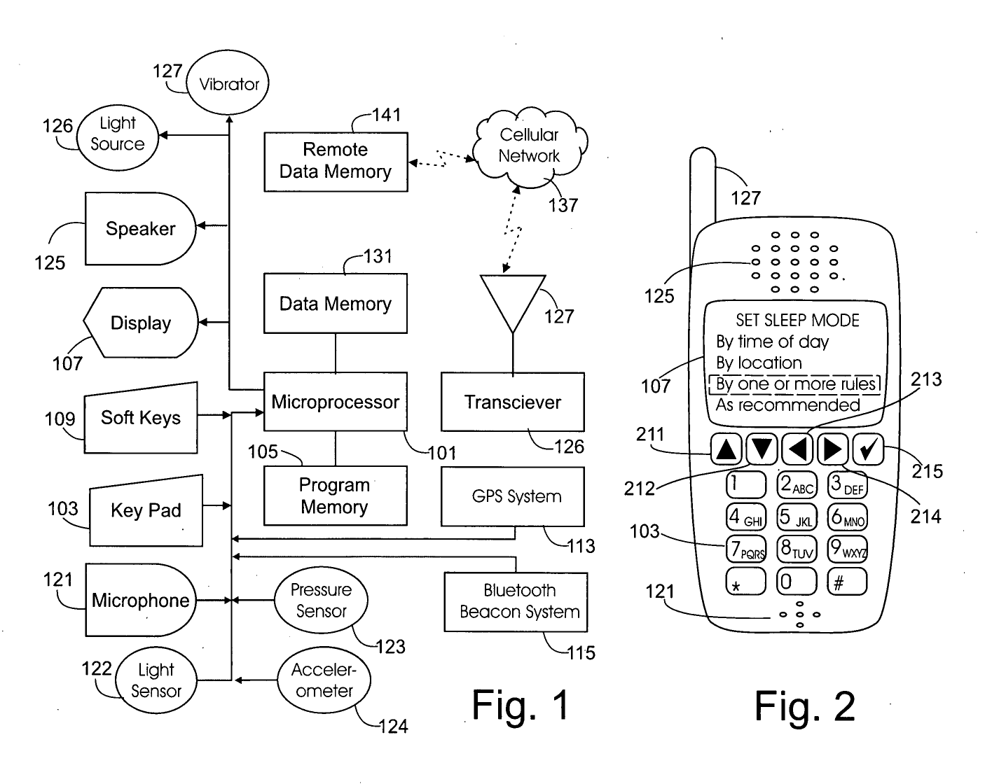

The invention may be implemented using conventional components of the type commonly used in such advanced cellular phone systems. The makeup and organization of these components is illustrated in FIG. 1 of the drawings and consists of a microprocessor 101 that executes routines initiated by the operator's manipulation of a keypad 103. Pressing a given key on the keypad 103 initiates a routine defined by a stored program in the program memory 105. The cellular phone further includes a display 107 that typically takes the form of a small, backlit monochrome or color LCD panel. The panel may be used to display a menu of items that may be selected by the user using “soft keys” seen at 109 that are visually associated with the displayed menu items. U.S. Pat. No. 5,737,394 entitled “Portable telephone apparatus having a plurality of selectable functions activated by the use of dedicated and/or soft keys,” the disclosure of which is incorporated herein by reference, describes the manner in which both the dedicated keys of a keypad and soft keys may be used in combination to implement a menu driven control arrangement for a cellular telephone. Alternatively, as will be described in more detail in connection with FIG. 2 of the drawings, the functions performed may be displayed as a list of options and cursor keys may be used to invoke selected functions and submenus identified on the display 107.

The cellular telephone preferable includes a built-in GPS system 113 which produces location data specifying the absolute geographic location of the cellular phone in latitude and longitude. This measured location may be compared with a location database to translate the measured position into data which is more easily understandable to the user, such as “Home”, “Office,” etc. Such a database may be remotely located and accessed by the telephone using the phones data communications capabilities discussed below and further described in the above-noted U.S. Pat. No. 6,788,766 issued to James D. Logan on Sept. 7, 2004 entitled “Methods and apparatus for providing location dependent cellular telephone communications.”

The cellular telephone also preferable includes a built-in Bluetooth transceiver which, in addition to other Bluetooth functions, operates as a Bluetooth beacon system 115 for detecting that other Bluetooth enabled objects are nearby, and for indicating its position to such objects. This Bluetooth beacon system may be supplemented with an RFID tag reader (not shown) for detecting and identifying nearby objects which are tagged with RFID tags. The cellular phone may also implement an MPS cellular location system. These mechanisms for sensing the absolute location of the portable phone, or its location relative to other objects or regions, are used to control the manner in which alert signals are sent to the user to indicate the arrival of incoming calls, and for other functions. Bluetooth, RFID and other mechanisms for determining the location of the cellphone and nearby objects, and for automatically performing defined functions when these locations satisfy programmed conditions, are described in the above-noted U.S. Pat. No. 6,996,402 issued to James D. Logan et al on Feb. 7, 2006 entitled “Rules Based Methods and Apparatus for Generating Notification Messages based on the Proximity of Electronic Devices to One Another.”

The cellular telephone further includes a microphone 121 for capturing spoken voice signals from the operator, a light sensor 122 for determining whether the cellular phone is in the dark, a pressure sensor or a capacitive sensorl23 for determining whether or not the telephone handset is being held, an accelerometer 124 for determining if the cellphone is at rest or in motion, a speaker or earpiece 125 for delivering audible sounds to the operator, and a cellular transceiver 128 coupled to an antenna 127 for sending and receiving radio frequency transmissions to and from the cellular telephone via the cellular network (and/or the public switched telephone network) to a remote telephone station set as illustrated at 125 by a cellular phone having like functionality. In addition to conventional ringing signals whose magnitude and timing can be controlled by the processor 101 as described in detail below, a light source 126 may be illuminated to provide a visual alert, and the cellular phone's vibrator 127 may be activated to provide a tactile signal that can be felt by the user, typically when an audible alert would be inappropriate. The magnitude and timing of the light and tactile signals may be controlled in accordance with data values indicating the status of the telephone in the same way that the magnitude and timing of audible ringing or other sounds are controlled. The term “mode” is commonly used herein to refer to particular set of alert generators (audible, visible or tactile) that is selected to suit particular sensed conditions. The manner in which a variety of functions can be automatically performed in response to status signals is described in detail in the above noted U.S. Patent Application Publication No. 2005/0153729 filed by James D. Logan et al. and in the co-pending application filed by James D. Logan on Oct. XX, 2006 entitled “Methods and apparatus for controlling cellular and portable phones,” which describes how status information and other data acquired by the cellular phone can be used to control the mode, magnitude and/or timing of alert signals such as audible ringing used to notify the user of incoming calls.

The light sensor 122 can be used to determine whether or not the telephone is in a dark location, such as a drawer, a briefcase or a coat pocket. The pressure sensor 123 or a capacitive sensor can be used to determine whether a cellular phone is being held or has been picked up. The accelerometer 124 can be used to determine whether the cellphone is in motion. All of these sensors may produced outputs that are recorded for a time, enabling a determination to be made, for example, of how long the phone has been in the dark, how long it has been held in the hand or effectively untouched, or how long it has been at rest without moving, or how long it has been vigorously in motion. Thus, by way of example, the microprocessor may process data from the light sensor, the accelerometer and the systems clock to determine when the phone has been in the dark and motionless for an extended time during daylight hours, and respond to that determination by automatically placing the phone in an inactive sleep mode for a predetermined time period, or until the light sensor or accelerometer indicates that the phone is no longer at rest and in the dark.

As noted earlier, while the embodiment of the invention described here uses a cellular telephone, the present invention is equally applicable to wired portable telephone station equipment connected to the public switched telephone system as well as with telephones which communicate in whole or in part via the Internet using VoIP connections. VoIP voice connections may also be established by a cellular phone via a WiFi connection to the Internet. VoIP connections may be controlled using the Session Initiation Protocol (SIP), an application layer control simple signaling protocol. SIP is defined and described in RFC 2543 and is a textual client-server based protocol SIP that is designed as part of the overall IETF multi-media data and control architecture currently incorporating protocols such as RTP, the Real-time Transport (RTP) Protocol (defined in RFC 1889). RTP provides end-to-end network transport functions suitable for applications that require a mechanism for transmitting real-time data such as audio, video or simulation data, over multicast or unicast network services. The SIP/RTP mechanism is accordingly a further example of the mechanism by which data may be transmitted via the telephone connection established for handling voice communications as contemplated by preferred embodiments of the invention.

The microprocessor 105 includes analog-to-digital conversion means for converting analog voice signals from the microphone 121 into digital form for storage in a data memory 131. In addition, using a text-editing program stored in program memory 105, the keypad 103 may be used to compose text messages, which are stored as character data in the data memory 131.

The cellular system transmits and receives both voice signals to provide conventional voice communications as well as data signals which can be exchanged with remote telephone stationsets and with network call centers which provide supervisory control of connected cellular phones. The cellular phone may be implemented, for example, using available technology such as the Motorola's iDEN i730 multi-communication device which provides a conventional, bidirectional audio voice communications channel as well as the additional TCP data communications channel which permits the exchange of data signals with a remote system illustrated by the remote data memory seen at 131 in FIG. 1. The iDEN i730 includes a built in processor 101 which can be programmed using the Java 2 Platform, Micro Edition, also known as the J2ME™ platform, which enables developers to easily create a variety of applications, as described in the i730 Multi-Communication Device J2ME™Developer's Guide, Motorola Corp. (2003).

FIG. 2 shows the exterior of an illustrative cellular telephone handset which houses the components shown in the block diagram of FIG. 1 and which employees the same reference numerals to identify the same components shown in block and pictorial form in FIGS. 1 and 2. The handset uses a conventional numeric keypad 103 for dialing and soft keys whose function depends on the content shown on the display 107. The soft keys include an UP cursor key 211, a DOWN cursor key 212, a LEFT cursor key 213, a RIGHT cursor key 214, and an OK key 215.

When a menu screen is displayed as seen at 210, the cursor keys 211-214 are used to highlight a selected one of several displayed labels, and the OK key 212 is used to invoke the operation designated by the selected label. For example, as seen in FIG. 2, the display screen 107 may display a scrollable listing of labels each of which specifies a particular one of a collection of prerecorded messages. By pressing the UP and DOWN cursor keys 211 and 212, the user may highlight a selected label on the scrollable list, and may select the highlighted message by pressing the OK key 215.

The cursor keys may be used to select and activate a variety of control functions or to set preferences using program generated menus. The program memory 105 may include voice recognition routines for converting spoken commands into interface commands for selecting and initiating functions. In order to differentiate conventional speech from voice commands, a selected soft key or dedicated key, or a unique spoken command, may be used to place the device in voice command mode. In voice command mode, the user may select and invoke a particular function by speaking the word or words corresponding to one of the displayed labels. In each case, because the total vocabulary of acceptable spoken commands is limited, a speech recognition program of limited capability of the kind now commonly incorporated in cellular telephones to implement voice commands may be used.

As contemplated by the present invention, the programs stored in the program memory 105 automatically perform a variety of operations in response to sensed status conditions. In addition, the operator may initiate and perform a number of interrelated functions, any one of which can be performed by beginning with menu as illustrated at 210 in FIG. 2. As illustrated at 210, for example, the operator of the cellular phone may select from a listed set of options to enter preference data which is stored by the processor 105 in the data memory 131 to control the manner in which battery conservation functions are activated under various conditions. For example, as illustrated by the menu displayed on the screen 107 as seen in FIG. 2, the user may select submenus which can be used to select preferences which determine how the cellular phone's sleep mode will be controlled by time of day, by location, by one or more rules (some of which may be satisfied by user-programmed status conditions such as the light or sound level in the phone's current surroundings, whether or not it is being held, and whether or not it is being moved. In addition, the phone may adaptively learn to detect status conditions which experiences shows may indicate that the phone is likely to be used, or unlikely to be used, and the “As recommended” submenu option will display those detected conditions and permit the user to confirm or reject the performance of “recommended” mode settings which are learned by the system (or preprogrammed by the cellphone vendor).

Power Saving Modes

Much of a cell phone's available battery power is consumed when the cell phone is doing nothing other than maintaining a communication link to a nearby tower. A SLEEPY phone on the other hand is able to more frequently enter into a sleep mode automatically under specified conditions. In the sleep mode, the phone only performs a limited set of functions, such as monitoring sensed environmental conditions, run a time clock, and/or perform a limited set of other functions that permit the phone to resume a more active state when that becomes appropriate. The degree to which different functions are disabled during a sleep state may depend on the conditions which caused the phone to enter the sleep state. Thus, for example, if the phone was placed in the sleep state because the user directed that it always be put to sleep between 1:00 am and 6:00 am every night, it would be unnecessary to monitor conditions other than the time of day, and the light sensor and accelerometer could be turned off, whereas under other conditions, it may be desirable that those sensors continue to function if the phone should be reactivated if moved or no longer in the dark.

Four different methods of saving power by turning off full phone functionality would ideally be built into a SLEEPY phone: reducing power usage (1) when the phone can't be used to receive calls, (2) when the user doesn't want calls, (3) when other things are being done with the phone, and (4) when the user chooses to use one of two new calling modes.

Turning Off Functions that Won't be Used

A SLEEPY system can incorporate one of more of the power reduction techniques disclosed in the patents previously identified in the “Discussion of the problem and prior solutions;” however, significant additional reduction in power consumption may be realized by utilizing the combination of additional “intelligent” power conservation techniques described below.

Based on Location

A large waste of battery power for many rural or suburban customers results from the fact that the phone is turned on when the phone is located where reception is very poor or non-existent. A cellular phone's GPS or MPS positioning subsystem may be employed to determine the current location of the phone which can then be compared to a mapping database stored locally or remotely that indicates regions where reception is known to be unavailable. Using such a map to determine the size of the dead-zone, and knowing the speed and direction at which cellphone is traveling, the phone could anticipate the coming availability of reception and restore normal functions in advance.

The portable telephone preferably employs location-based information in combination with environmental data, time-of-day information, and user preferences to automate in whole or in part the selection of a sleep or active mode that is appropriate under detectable circumstances.

Thus, in this implementation, a user's phone would glean location data from a built-in technology such the GPS system, portable 911-triangulation, or even a locally-based system, such as a system of distributed Bluetooth beacons, that can specify the location of the portable phone within a building. The user would have the option to set preferences regarding when and where the portable telephone should be active and when it should be put to sleep in those locations. Thus, in church or theater, it would be desirable that the phone be placed in the sleep mode, while at the doctor's office it might be desirable that the phone be placed in an active mode with the alert mechanism set to vibrate mode.

Since, in many situations, a directive to switch the phone into sleep mode may be issued automatically, it will frequently be desirable that the phone display or otherwise indicate to the user that the phone had undergone or will undergo an automated mode change. This could be indicated by a unique (or standard) sound, light indicator, or vibration pattern, and an accompanying explanatory display message.

By storing a list of location-sleep mode or location-active mode relationships, the system can adaptively learn and automatically place the phone in the operating mode that is appropriate. For example, every time the user is in a new movie theatre, and he sets his phone to the sleep or vibrate mode, the phone would ask whether the user wants this setting to be made permanent, or for one or more calls only. If the location sensing mechanism can determine the absolute or relative location at the time the mode is manually reset, the user may also be asked to indicate whether that new mode setting is to be applied whenever the existing location is again detected.

A central server with a stored map database (e.g. “Google Map” data or a web service that can be accessed via the Internet) might also know that the location where the setting is being made is a movie theatre. The user, therefore, when setting his phone for a particular sleep mode or alert (ringing or vibrate) mode would be asked if she would like this same setting to apply to all movie theatres. The time of day and day of the week when the change occurs may also be learned, and the form one of the conditions which must be satisfied before an automated mode change is made in the future.

The user may personalize classes of locations by associating a default sleep and/or alert mode with each class. Thus, for example, the user may designate all movie theatres as locations where the cellphone should to be automatically placed in a sleep mode. Alternatively, the first time a cellphone is located in a movie theatre, the user may be requested (preferably getting her attention using the vibrate mode) regarding how the user might like the phone set up at that time, and further asked if the selected mode should be used for all movie theaters. The map data which classifies locations may contain a recommended default setting for locations of a particular kind. For example, all theaters, churches and libraries may be designated as sleep mode areas unless the user alters the setting for a particular class (for example, resetting libraries to an active mode with a vibrate alert setting). Similarly, the recommended settings for any specific location can be overridden completely.

When the portable phone has been programmed to recognize that it has arrived at a location, or has otherwise detected conditions which would cause a change in the phone's operating mode, the user may be notified and asked to confirm that the change should be made. The user may also program certain conditions to automatically change the mode without seeking confirmation.

Another method of setting active/sleep mode and alert (ring/vibrate/silent) mode would be to do so “globally”. In this method, the user would ask the phone (which would work in conjunction with the server and other data sources) to deduce the social setting and ambient sound characteristics of whatever location the user found himself in. Thus, using a detailed database that could correlate GPS coordinates or other location data with building types, functions (subway stations), and settings (outdoors at the beach), the system could make certain deductions concerning where and when the phone should be placed in sleep mode.

When the user is in motion, rules-based location sensing or GPS motion detection, or the accelerometer 124, may be able to discern when a user is starting to move about. At that point, the system might automatically switch the mode setting. For instance, if the user started to move within a movie theatre, the system might deduce the movie was over and thus return the phone to its active setting. This mode change could occur after a set time period (for instance two minutes after movement began) or based on distance (once the user had moved 100 feet). Alternatively, perhaps when arriving at the theatre, the phone might be placed in sleep mode only after the user was seated, either for a moment or a set number of minutes, as indicated by the accelerometer. In any of these cases, (arriving, leaving, or even going to the concession stand) the movement data could reasonably discern that a change had occurred so that cellphone used had become socially acceptable. The switch from the sleep mode could be made before the phone was permitted to ring rather than vibrate, and distance and time settings could be established by default settings for particular locations, or set by each user.

In addition to responding to such absolute location information, data concerning location relative to other devices and things may be used to control power consumption by turning the full phone functionality on and off. As described in my U.S. Pat. Nos. 6,631,271, 6,788,766 and 6,996,402, rules-based processing may be employed to trigger specified functions when a cellular phone and one or more other objects have predefined relative positions or distances from one another. In this way, for example, a cellular phone may be placed in sleep mode automatically when it is determined that it is located to far from its user to be answered, or is located in a place where it should not be answered, or when a combination of sensed status values is indicative of a condition when the use of the telephone would be difficult or inappropriate. Using the rules-based processing techniques described in the foregoing patents, the user may define the conditions which, when satisfied, cause the phone to be placed in a sleep mode automatically.

Based on Time

An alternative to using GPS predictive reception, the SLEEPY phone may employ a time-based algorithm to identify locations where reception is likely to be unavailable. In addition to responding to a specified schedule accepted from the user, the system can adaptively acquire a database of times of the day and days of the week when reception is bad. For instance if the user spent much of each workday in a location where reception was unavailable, this pattern could be readily detected by analyzing data recording the times when reception was unavailable. The cellular phone could then be automatically placed in sleep mode during those times.

The user may indicate that calls are not to be accepted (and hence the cellphone put to sleep) during scheduled occasions, such as planned meetings, doctors' appointments, and school classes. These event times (start and end times) may be manually entered by the user. Alternatively, when a user employs calendar scheduling software on a PC, PDA, or a calendar scheduling system built into the cellular phone, the cellular phone can be automatically placed in sleep mode during the times scheduled for selected activities by these programs. By way of example, the user may be provided with a check box which can indicate whether calls will be accepted during an activity that the user is scheduling.

As noted earlier, the user is provided with the ability to independently indicate the times when the phone is to power-down. Thus, a user who does not wish to be disturbed while sleeping, would schedule an automatic power down during specified hours each night. Even if the phone was placed in its charger overnight (so that charge conservation is a less important objective), this feature further serves to deflect calls to voice mail so that phone will not ring when calls are not wanted.

Saving Power When the Phone is Activated

The sensing mechanisms (light sensor, accelerometer, microphone, pressure sensor) described above in connection with FIG. 1 may be used to advantage when the phone is active to reduce power consumption and to perform other useful functions. for example, the light sensor 122 may be used to control the intensity of illumination of the display screen or illuminated keys to an appropriate level and thereby conserve power. The volume produced by the speakers 125 may be automatically reduced when there is low ambient noise in the vicinity of the phone. The display illumination may be normally turned OFF, and automatically turned ON for a timed interval whenever the accelerometer indicates the phone has been moved for the first time after a period of being at rest. Similarly, the pressure sensor may be used to activate the phone whenever it's picked up while in a sleep mode. As with other functions, rules-based processing allows combinations of these sensed variables to determine the manner in which various components and subsystems of the cellular phone operate under specified conditions.

Sleep Mode When Alternate Connections are Available

Cellular phones increasingly provide WiFi connectivity. By way of example, Motorola has introduced “Seamless Cellular-To-VoIP” capabilities that transfer voice calls in-session, from the cellular to the VoIP network established using a WiFi connection employing broadband VoIP, the cellular infrastructure, and 802.11b/g consumer premise WiFi base stations working together with a dual-mode WiFi®/cellular handsets to facilitate a smooth call handoff. When such a phone transfers is using the WiFi connection instead of a cellular connection, the components supporting the cellular connection may be placed in a sleep mode until the WiFi connection is terminated.

Similarly, many cellular, VoIP and wireline phone services make it easy to forward calls directed to a particular phone number to ring at one or more other numbers, and these call forwarding features can frequently be scheduled so that forwarding occurs automatically in different ways at different times. When calls directed to the cellular phone are being forwarded, the cellular phone may be put to sleep to conserve power. Accordingly, the cellular phones menu selections preferably allow the user to indicate that the cellular phone should be shut down when calls that would normally be directed to that phone are being forwarded elsewhere. Preferably, the service which performs the call-forwarding should send a notification message to the cellular phone indicating when calls are being forwarded. When call forwarding is performed on a scheduled basis, the cellular phone can schedule the sleep mode accordingly. The cellular phone should reawaken periodically to the extent necessary to confirm that calls are still being forwarded before returning to the sleep mode.

Enhanced Sleep Mode Functions

Today the phone system uses largely a “push-first” model; that is, incoming calls are pushed to the called party. If the party called isn't available or cannot take the call, or has turned the phone off, the call goes into voice mail. At this time, accepting the call becomes a “pull action” to retrieve the message. Attempts have been made to make the pull action easier, largely through attempts by the cellular provider to notify the user when a voice mail has been left.

Users can elect to operate the phone as “pull” device by turning if off, or by setting a silent alert (that is, no ring or vibrate, or other indications of an incoming call), and then relying on receiving voicemail notifications from the cellular provider in order to know when to retrieve messages and to learn of missed calls. This system works reasonably well for people who don't want to be disturbed for whatever reason and if the cellular provider's notification system operates effectively.

As just described with conventional phones, this approach does nothing to conserve battery power as the phone is typically on and consuming energy while awaiting notification that a voice mail has arrived Using the “pull” method with the SLEEPY phone, however, yields a meaningful extension of battery life. When the phone is in sleep mode at times selected by the user, it may be reawakened at scheduled times to obtain notification messages from the cellular provider, including information about missed calls and voice and text messages received by the provider while the phone was in sleep mode. Upon awakening, the phone would either wait for the cellular provider to communicate this information, or the phone could fetch this information by dialing voice mail.

Preferably, however, whenever a cellular phone is placed in sleep mode, it could send a notification message to the cellular phone provider. When the sleep mode is to persist for a scheduled time period, the duration of the planned sleep mode would also be sent. In this way, the cellular provider could more rapidly respond to incoming calls by routing them immediately to voice mail, and could also send an announcement message to callers indicating that the called party would be unavailable until a stated time. When the phone's sleep mode ended, information describing incoming call and message activity during the sleep mode period could immediately be transmitted to and stored by the cellular phone. If pending voice mail or unread text messages were available, the cellphone could produce an audible or visible alert signal to notify the user. When the cellular phone is placed in a longer sleep mode from which it periodically awakes, the cellphone could fetch pending message and voice mail information before resuming the sleep mode.

The cellphone may be placed in a “semi-sleep” mode in which it is normally conserving power but intermittently communicates after an interval of, say, 2-10 seconds. To reduce the likelihood that calls will be missed, the duration of the ring signal would be adjusted to longer period that until, say, 20 seconds after a sleep interval started. Because the cellular provider would be aware of the sleep cycle timing, it could send an announcement to the caller that says in effect, “We are trying to locate that party, please wait,” when it is know that the phone will not actually ring until the phone reawakes. In his way, battery consumption is significantly reduced while maintaining the ability of a caller to reach the called party.

To simplify the setup of the cellular phone, methods for invoking the sleep mode may be grouped and selected as a group. For example, the user may choose between the modes of “semi-sleep,” “sleep,” “deep sleep,” and “off.” In the semi-sleep mode described above, the phone is reawakened frequently to check for incoming calls. In the sleep mode, a more prolonged period may exist before the phone is periodically reawakened, and the phone's status sensors may be active to reawaken the phone in the event certain events are detected. In the deep sleep mode, the phone may remain asleep until the deep sleep's scheduled period ends, and the phone would not respond to many if not all of the sensed events that would normally awaken the phone. In the off position, all power is removed and the phone can only be reactivated by manually turning it on again. Note that all of these modes may be automatically initiated on a user-defined time schedule or by rules-based processing as described above.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. Apparatus for placing a portable telephone in a reduced-power sleep mode comprising, in combination,
one or more inputs for acquiring one or more data values indicating the current status of said portable telephone,
means for processing said data values to produce a sleep command when said current status indicates that incoming calls directed to said portable telephone will not or should not be answered,
means responsive to said sleep command for placing said portable telephone in said reduced-power sleep mode when said data

2. Apparatus for placing a portable telephone in a reduced-power sleep mode as set forth in claim 1 wherein at least one of said data values indicates the current location of said portable telephone.

3. Apparatus for placing a portable telephone in a reduced-power sleep mode as set forth in claim 2 wherein said one of said data values that indicates the current location of said portable telephone is obtained by sensing the amplitude of a signal transmitted from a remote beacon source having a known location.

4. Apparatus for placing a portable telephone in a reduced-power sleep mode as set forth in claim 2 wherein said one of said data values that indicates the current location of said portable telephone is obtained using the Global Positioning System.

4. Apparatus for placing a portable telephone in a reduced-power sleep mode as set forth in claim 2 wherein at least one of said data values indicates the location of said portable telephone relative to the location of another object.

5. Apparatus for placing a portable telephone in a reduced-power sleep mode as set forth in claim 1 wherein at least one of said data values indicates the level of ambient sound at said portable telephone.

6. Apparatus for placing a portable telephone in a reduced-power sleep mode as set forth in claim 5 wherein at least one of said data values indicates the level of ambient light at said portable telephone.

7. Apparatus for placing a portable telephone in a reduced-power sleep mode as set forth in claim 1 wherein at least one of said data values indicates the level of ambient light at said portable telephone.

8. Apparatus for placing a portable telephone in a reduced-power sleep mode as set forth in claim 1 wherein said portable telephone produces an alert notification signal indicating that an incoming telephone call has been directed to said portable telephone and wherein the magnitude or timing of said notification signal is controlled in accordance with said data valies indicating the current status of said portable telephone.

9. A method for reducing the energy consumed by a battery-operated portable telephone comprising, in combination, the steps of:
producing an indication of the current position of said portable telephone, and
disabling one or more power consuming components of said portable telephone in a manner dependent on said indication of the current position of said portable telephone.

10. A method for reducing the energy consumed by a battery-operated portable telephone as set forth in claim 9 wherein said step of producing said indication of the current position of said portable telephone specifies said position relative to the current location of another object, person or region.

11. A method for reducing the energy consumed by a battery-operated portable telephone as set forth in claim 10 wherein said current location of another object, person or region is the current location of a beacon that emits a signal that can be detected by a sensor in said portable telephone when portable telephone is in the vicinity of said beacon.

12. A method for reducing the energy consumed by a battery-operated portable telephone as set forth in claim 10 wherein said current location of another object, person or region is the current location of the human user of said portable telephone.

13. A method for reducing the energy consumed by a battery-operated portable telephone as set forth in claim 10 wherein said current location of another object or person is the current location of a predetermined fixed geographical region.

14. A method for reducing the energy consumed by a battery-operated portable telephone as set forth in claim 9 wherein said portable telephone produces an alert notification signal indicating that an incoming telephone call has been directed to said portable telephone and wherein the magnitude or timing of said notification signal is controlled in accordance with indication of the current position of said portable telephone.
